(19) United States
(12) Patent Application Publication
(10) Pub. No.: US 2006/0056619 A1
(43) Pub. Date: Mar. 16, 2006

(54) Method for universal calculation applied to points of an elliptic curve

(75) Inventors: Olivier Billet, Tourrettes sur Loup (FR); Marc Joye, Saint Zacharie (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Gemplus, La Ciotat Cedex (FR)

(21) Appl. No.: 10/523,840

(22) PCT Filed: Aug. 5, 2003
(86) PCT No.: PCT/FR03/02462

§ 371 Date: Aug. 18, 2005

(30) Foreign Application Priority Data
Aug. 9, 2002 (FR) 02/10193

(51) Int. Cl. H04L 9/28; H04L 9/00; H04K 1/00

(52) U.S. Cl. 380/28; 380/44

(57) ABSTRACT

A method for universal calculation on the points of an elliptic curve defined by a quartic equation uses identical programmed calculating devices for operating an addition of points, a doubling of points and an addition of a neutral point. The calculating device is a central unit associated with a memory. The invention also concerns a cryptographic method using such a universal method. The invention further concerns a component for implementing the universal calculation method and/or the cryptographic method. For example, the invention is applicable to smart cards.

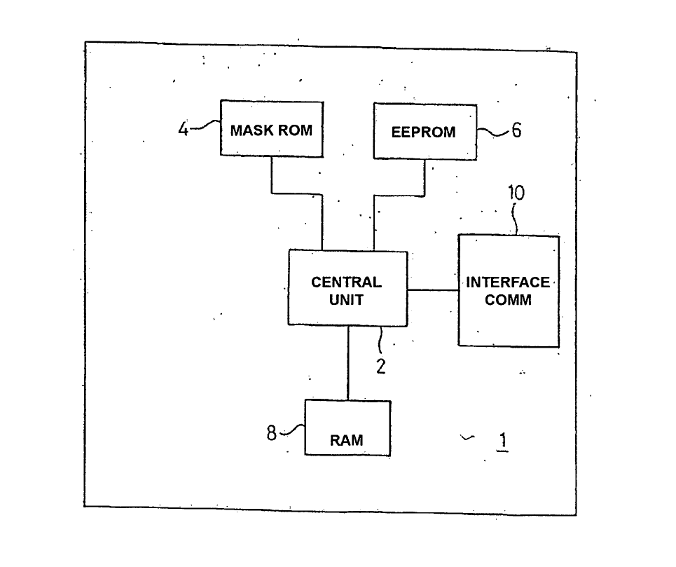

The present invention concerns a universal calculation method applied to points on an elliptic curve, and an electronic component comprising means of implementing such a method. The invention is in particular applicable for the implementation of cryptographic algorithms of the public key type, for example in smart cards.

Public key algorithms on an elliptic curve allow cryptographic applications of the ciphering, digital signature, authentication, etc. type.

They are in particular much used in applications of the smart card type, since they make it possible to use keys of short length, permitting fairly short processing times, and they may not require the use of cryptoprocessors for their implementation, which reduces the production cost of the electronic components in which they are implemented.

Before going further, a few reminders about elliptic curves should be given first of all.

The points on an elliptic curve are defined over a field K and form an Abelian group E(K), in which the group operation is the addition of points denoted +, and where a neutral element denoted O is distinguished.

For a finite field, the cardinal of E(K) is finite. There therefore exists for any point P an integer m such that:
O=m.P=P+P+ . . . +P, m times
and such that, for any integer k<m, k.P # 0. Such an integer m is referred to as the order of P. In this case, m divides the cardinal of E(K).

Certain curves have particular properties. For example, an elliptic curve having a point of order two has a cardinal divisible by 2. Or, an elliptic curve having a point of order three is a curve such that the cardinal of the group E(K) is divisible by 3. Curves having the same particular property are grouped together in the same family.

A point on an elliptic curve can be represented by several types of coordinate, for example by affine coordinates or Jacobi projective coordinates.

Various models exist for defining an elliptic curve applicable in cryptography. A commonly used model is the so-called Weierstrass model. The Weierstrass model is very general since any elliptic curve can come under this model.

Each model can be used by means of the different types of coordinate.

For example, in affine coordinates and where the characteristic p of the field K is different from 2 and 3, the Weierstrass model is defined as follows: the neutral point 0 (the point at infinity in the Weierstrass model) and the set of points (X, Y) χ K×K satisfying the equation:
E/K: Y²=X³+a*X+b (F1)
with a, b χ K such that 4a³+27b²≠0, form the group of rational points on an elliptic curve E(K). The point P can also be represented by Jacobi projective coordinates of the general form (U, V, W). (X, Y) and (U, V, W) are linked by the following equations:
   X=U/W and Y=V/W² (F2)

With these Jacobi projective coordinates, the Weierstrass equation of an elliptic curve becomes:
E/K: V²=U³+a*UW⁴+b*W⁶ (F3)

Projective coordinates are in particular advantageous in exponentiation calculations applied to points on an elliptic curve, since they do not comprise any inversion calculations in the field.

As shown by the formula F2, one and the same point has several possible representations in Jacobi projective coordinates. Also, the following equivalence relationship is defined over K³\{(0, 0, 0)}: two elements, with coordinates (U, V, W) and (U′, V′, W′), are referred to as equivalent and belong to the same equivalence class if and only if there exists a non-null element λ of K such that
(U′, V′, W′)=λU, λ²V, λW) (F4)

The coordinates of an element of this class are denoted (U:V:W).

According to the model which defines the elliptic curve and according to the coordinates used for working, different formulae for addition, subtraction and doubling of points are applicable. In the case of the Weierstrass model, such formulae are known and given by the well-known secant and tangent rule.

In the example of an elliptic curve E given by a Weierstrass model in affine coordinates over a field with characteristic different from 2 and 3, the simplest formulae for addition, subtraction and doubling of points are as follows.

The inverse of a point P1=(X1, Y1) on the curve E is the point −P1=(X₁,\overline{Y}₁) with
\overline{Y}1=−Y1 (F5)

The operation of addition of points P1 with coordinates (X1, Y1) and P2 with coordinates (X2, Y2) on this curve, with P1≠−P2, gives the point P3=P1+P2 whose coordinates (X3, Y3) are such that:
X3=λ²−X1−X2 (F6)
Y3=λ×(X1−X3)−Y1, (F7)
with
   λ=(Y1−Y2)/(X1−X2), if P1≠P2 (F8)
   λ=(3×X1²+a)/(2×Y1), if P1=P2 (F9)

The formula F8 is used for adding two distinct points (P3=P1+P2) whilst the formula F9 is used for a point doubling operation (P3=2×P1).

The formulae F6 to F9 are not valid when P1 and/or P2 is equal to the neutral point O. Most often, in practice, an operation of the type P3=P1+O is not carried out. More simply, before an addition operation of the type P3=P1+P2 is carried out, it is tested whether at least one of the points is equal to the neutral O. The operation P3=P1 is then carried out if P1=O or the operation P3=P2 is carried out if P2=O.

The operations of addition or subtraction, or doubling of a point, and the operation of addition of the neutral are the basic operations used in scalar multiplication algorithms on elliptic curves: given a point P1 belonging to an elliptic curve E and d a predetermined number (an integer), the result of the scalar multiplication of the point P1 by the number d is a point P2 on the curve E such that P2=d×P1=P1+P1+ . . . +P1, d times. It should be noted that, if P1 is of order n, then n×P1=O, (n+1)×P1=P1+O=P1, etc., O being the neutral point.

Public key cryptographic algorithms on an elliptic curve are based on the scalar multiplication of a selected point P1 on the curve by a predetermined number d, a secret key. The result of this scalar multiplication d×P1 is a point P2 on the elliptic curve. In an example of application to ciphering according to the El Gamal method, the point P2 obtained is the public key which is used for the ciphering of a message.

The calculation of the scalar multiplication P2=d×P1 can be carried out by various algorithms. A few of them can be cited, such as the double and add algorithm based on the binary representation of the multiplier d, the so-called “addition/subtraction” algorithm based on the signed binary representation of the multiplier d, the window algorithm, etc.

All these algorithms use the formulae for addition, subtraction, doubling and addition of the neutral defined on elliptic curves.

However, these algorithms prove to be sensitive to attacks aiming to discover in particular the value of the secret key d. There can be cited in particular the simple or differential covert channel attacks.

Simple or differential covert channel attack means an attack based on a physical quantity measurable from outside the device, and whose direct analysis (simple attack) or analysis according to a statistical method (differential attack) makes it possible to discover information contained and manipulated in processing in the device. These attacks can thus make it possible to discover confidential information. These attacks have in particular been disclosed in D1 (Paul Kocher, Joshua Jaffe and Benjamin Jun. Differential Power Analysis. Advances in Cryptology—CRYPTO'99, vol. 1666 of Lecture Notes in Computer Science, pp. 388-397. Springer-Verlag, 1999). Amongst the physical quantities which can be exploited for these purposes, there can be cited the execution time, the current consumption, the electromagnetic field radiated by the part of the component used for executing the calculation, etc. These attacks are based on the fact that the manipulation of a bit, that is to say its processing by a particular instruction, has a particular impression on the physical quantity in question according to the value of this bit and/or according to the instruction.

In the cryptographic systems based on elliptic curves, these attacks aim to identify an operation (for example an addition of points of the type P3=P1+P2, an addition of the type P3=P1+O, or a scalar multiplication of the type P3=d*P1) in a set of operations carried out successively.

If the example of a scalar multiplication algorithm on elliptic curves with the Weierstrass model is taken, this algorithm may be sensitive to simple covert channel attacks, since the basic operations of doubling of points, addition of points or addition of the neutral point are substantially different as shown by the calculation of lambda in the formulae F8 and F9 above.

It is therefore necessary to provide countermeasure methods making it possible to prevent the various attacks from prospering. In other words, it is necessary to make the scalar multiplication algorithms secure.

For this, from D2 (Eric Brier and Marc Joye. Weierstrass elliptic curves and side-channel attacks. In D. Naccache, editor, Public Key Cryptography, volume 2274 of Lecture Notes in Computer Science, pages 335-345. Springer-Verlag, 2002), a single formulation for a doubling of points operation and an addition of points operation is known. Thus, the two operations can no longer be differentiated by a covert channel attack. This formulation however has the drawback of not being valid for carrying out an operation of addition of the neutral point.

From D3 (Pierre-Yvan Liardet and Nigel P. Smart. Preventing SPA/DPA in ECC systems using the Jacobi form. In C. K. Koç, D. Naccache, and C. Paar, editors, Cryptographic Hardware and Embedded Systems—CHES 2001, volume 2162 of Lecture Notes in Computer Science, pages 391-401. Springer-Verlag, 2001), a single formulation for an addition operation and a doubling of points operation is also known. This formulation however is applicable only within the context of an elliptic curve having three points of order 2. Moreover, the formulation proposed in D3 requires considerable memory space in order to be implemented since the points are stored with four coordinates. This is not easily compatible with a smart card type application.

From D4 (Marc Joye and Jean-Jacques Quisquater. Hessian elliptic curves and side-channel attacks. In C. K. Koç, D. Naccache, and C. Paar, editors, Cryptographic Hardware and Embedded Systems—CHES 2001, volume 2162 of Lecture Notes in Computer Science, pages 402-410. Springer-Verlag, 2001), a single formulation for an addition operation and a doubling of points operation is also known. However, this formulation is applicable solely to elliptic curves having a point of order three.

D3 and D4 do not mention the problem of addition of the neutral.

One aim of the invention is to propose a solution for protection against covert channel attacks, in particular SPA attacks, which is more efficient than the solutions already known.

Another aim of the invention is to propose a solution which can be implemented in a circuit having not much memory space available, with a view for example to a smart card type application.

These objectives are achieved in the invention by a single formulation making it possible to carry out an addition of two distinct points, a doubling of points, and an operation of addition of the neutral. The said formulation according to the invention is moreover minimal: thus the number of operations to be performed and the memory space necessary for its implementation are limited.

Thus, the invention concerns a method of universal calculation on points on an elliptic curve. According to the invention, the elliptic curve is defined by a quartic equation and identical programmed calculation means are used to carry out an operation of addition of points, an operation of doubling of points, and an operation of addition of a neutral point, the calculation means comprising in particular a central processing unit associated with a memory.

In other words, according to the invention, the use of a model of the elliptic curve in the form of a quartic (that is to say a 4^{th} degree polynomial) makes it possible to use a single formulation for carrying out operations of addition of points, point doubling and addition of the neutral point of the curve.

It then becomes impossible to distinguish one of these operations from the others by an attack such as a covert channel attack.

Furthermore, the use of a model of the curve in quartic form makes it possible to represent a point by means of only 3 projective coordinates, which limits the memory space necessary for storing the coordinates of a point and reduces the calculation times during operations on points.

Finally, as will be seen more clearly in examples, the single formulation obtained according to the invention for carrying out three types of addition (addition of two distinct points, doubling of points and addition of the neutral) uses a limited number of elementary operations of multiplication type, which further limits the calculation times and memory space necessary.

The invention also concerns the use of a universal calculation method as described above, in a scalar multiplication calculation method applied to points on an elliptic curve, and/or in a cryptographic method.

The invention also concerns an electronic component comprising programmed calculation means for implementing a universal calculation method as described above or a cryptographic method using the above universal calculation method. The calculation means comprise in particular a central processing unit associated with a memory.

Finally, the invention also concerns a smart card comprising the above electronic component.

The invention and the advantages ensuing therefrom will emerge more clearly from a reading of the following description of particular example embodiments of the invention, given on a purely indicative basis and with reference to the single accompanying figure. This depicts in block diagram form an electronic device 1 capable of carrying out cryptographic calculations.

In the following examples, the device 1 is a smart card intended to execute a cryptographic program. To that end, the device 1 combines, in a chip, programmed calculation means, consisting of a central processing unit 2 functionally connected to a set of memories including:
a memory 4 accessible in read mode only, in the example of the mask ROM (mask read-only memory) type;
an electrically re-programmable memory 6, in the example of the EEPROM (electrically erasable programmable ROM) type; and
a working memory 8 accessible in read mode and write mode, in the example of the RAM (random access memory) type. This memory comprises in particular calculation registers used by the device 1.

The executable code corresponding to the scalar multiplication algorithm is contained in program memory. This code can in practice be contained in memory 4, accessible in read mode only, and/or in rewritable memory 6.

The central processing unit 2 is connected to a communication interface 10 which provides the exchange of signals with regard to the outside and the power supply for the chip. This interface can comprise pads on the card for a so-called “contact” connection with a reader, and/or an antenna in the case of a so-called “contactless” card.

One of the functions of the device 1 is to cipher or decipher a confidential message m respectively transmitted to, or received from, the outside. This message may concern for example personal codes, medical information, accounting on banking or commercial transactions, authorisations for access to certain restricted services, etc. Another function is to calculate or verify a digital signature.

In order to carry out these functions, the central processing unit 2 executes a cryptographic algorithm on programming data which are stored in the mask ROM 4 and/or EEPROM 6 parts.

The algorithm used here is a public key algorithm on an elliptic curve within the context of a model in the form of a quartic. The concern here will more precisely be with a part of this algorithm, which makes it possible to carry out basic operations, that is to say addition operations: addition of two distinct points, of two identical points (that is to say an operation of doubling of a point), or of any point whatsoever and the neutral point.

It should be noted that, according to the invention, these three operations are carried out using the same formulation and are therefore not distinguishable from one another from the outside for a simple covert channel attack.

Within the context of the invention, the concern is with the elliptic curve models defined by a quartic equation instead of the Weierstrass cubic equation usually used.

The general form of a quartic, in affine coordinates, is given by the equation:
Y²=a0.X⁴+a1.X³+a2.X²+a3.X+a4 (F10)
or, in Jacobi projective coordinates, by the equation:
   V²=a0.U⁴+a1.U³W+a2.U²W²+a3.UW³+a4W⁴ (F11)
   knowing that the affine coordinates and the Jacobi projective coordinates of the same point are linked by the relationship:
   (X, Y)=(U/W, V/W²) (F12)

In a first example embodiment of the invention, any elliptic curve whatsoever is considered, and an operation of the type P3=P1+P2 is carried out, with P1, P2 any two points whatsoever on the elliptic curve. P2 can be different from P1, equal to P1 and/or equal to the neutral O of the curve. The addition operation is carried out in Jacobi projective coordinates.

It is shown that any curve with equation
Y=X³+a.X+b (Weierstrass equation)
is birationally equivalent to a curve with equation
   Y²=b.X⁴+a.X³+X (F13)

The equation F13 is ultimately a particular case of the equation F10, with a0=b, a1=a, a2=0, a3=1, a4=0.

Using the equivalence relationships F12, it is shown that the equation F13 can also be written, in Jacobi projective coordinates:
V²=b. U⁴+a. U³W+UW³ (F14)

When the scalar multiplication calculation device is called upon to carry out an addition operation, the central processing unit 2 first of all stores in calculation registers the coordinates (U1:V1:W1) and (U2: V2: W2) of the points P1, P2 on the elliptic curve which are to be added.

The central processing unit 2 next calculates the coordinates of the point P3 according to the equations:

$$\begin{matrix}\begin{matrix}U3 = 2. b . {U1}^{2} . {U2}^{2} + \\ ( aU1 . U2 + W1 . W2 ) . ( U1 . W2 + W1 . U2 ) + \\ 2 V1 . V2\end{matrix} & ( F15 ) \\ \begin{matrix}V3 = {( {U1}^{2} . V2 + {U2}^{2} . V1 )}^{*} ( 4 b . ( U1 . W2 + U2 . W1 ) . W1 . W2 - \\ 8 {b}^{2} . {( U1 . U2 )}^{2} + a . [ {( 2 W1 . W2 )}^{2} - {( aU1 . U2 + W1 . W2 )}^{2} ] + \\ {( {W1}^{2} . V2 + {W2}^{2} . V1 )}^{*} [ {( aU1 . U2 + W1 . W2 )}^{2} - {( 2 aU1 . U2 )}^{2} + \\ 4 bU1 . U2 . ( W1 . U2 + U1 . W2 ) ] - \\ - 4 bU1 . U2 . ( U1 . W1 . V2 + U2 . W2 . V1 ) ( aU1 . U2 - W1 . W2 )\end{matrix} & ( F16 ) \\ W3 = {( aU1 . U2 - W1 . W2 )}^{2} - 4 bU1 . U2 ( U1 . W2 + U2 . W1 ) & F17 )\end{matrix}$$

The coordinates (U3: V3: W3) of the point P3 are finally stored in registers in the working memory 8, in order to be used elsewhere, for example for the remainder of the ciphering algorithm.

It is verified that the formulae F15 to F17 are valid, even in the case where P1=P2 (point doubling) or in the case where P2=O(0:0:1) (addition of the neutral).

In a second example embodiment of the invention, an elliptic curve having a single point of order two with affine coordinates (θ, 0) is considered, and an operation of the type P3=P1+P2 is carried out, with P1, P2 any two points whatsoever on the elliptic curve. P2 can be different from P1, equal to P1 and/or equal to the neutral O of the curve. The addition operation is given in Jacobi projective coordinates.

The point of order two satisfying the Weierstrass equation defining the elliptic curve, θ, is defined by the equation:
θ³+a.θ+b=0

It is then shown that any curve with equation
Y²=X³+a.X+b (Weierstrass equation)
and having a single point (θ, 0) of order two is birationally equivalent to a curve with equation
   Y²=ε.X⁴˜2δ.X²+1 (F18)
   with:
   ε=−(a+3θ²/4)/4 and δ=3θ/4 (F19)

The equation F18 is ultimately a particular case of the equation F10, with a0=ε, a1=0, a2=−2δ, a3=0, a4=1.

Using the equivalence relationships F12, it is shown that the equation F18 can also be written, in Jacobi projective coordinates:
V²=ε.X⁴−2δ.U²X²+W⁴ (F20)

The change from the cubic model Y²=X³+aX+b to the quartic model Y²=ε.X⁴−2δ.X²+1 is performed by the following transformations:

| Weierstrass | | Quartic |
|---|---|---|
| model | | model |
| (θ, 0) | ξ | (0 : −1 : 1) |
| (X, Y) | ξ | (2(X − θ) : (2X + θ) (X − θ)² − Y² : Y) |
| ο | ξ | (0 : 1 : 1) |

| Quartic | | Weierstrass |
|---|---|---|
| model | | model |
| (0 : 1 : 1) | ξ | ο |
| (0 : −1 : 1) | ξ | (θ, 0) |
| (U : V :W) | ξ | (2(V + W²)/U² − θ/2, W(4V + 4W² − 3θU²)U³) |

There are defined for this quartic model the neutral point O (0:1:1) and the inverse point of the point P (U:V:W) by the point −P (−U:V:W).

When the exponentiation calculation device is called upon to carry out an addition operation, the central processing unit 2 first of all stores in calculation registers the coordinates (U1:V1:W1) and (U2:V2:W2) of the points P1, P2 on the elliptic curve which are to be added.

The central processing unit 2 next calculates the coordinates of the point P3 according to the equations:
U3=U1.W1.V2+V1.U2.W2 (F21)
V3=[(W1.W2)²+ε(U1.U2)²]*[V1.V2−2δU1.U2.W1.W2]+2ε.U1.U2.W1.W2(U1²W2²+W1²U2²) (F22)
W3=(W1.W2)²−ε(U1.U2)² (F23)

The coordinates (U3:V3:W3) of the point P3 are finally stored in registers in the working memory 8, in order to be used elsewhere, for example for the remainder of the ciphering algorithm.

Here again it is verified that the formulae F21 to F23 are valid, even in the case where P1=P2 (point doubling) or in the case where P2=O (addition of the neutral).

In the third example embodiment of the invention, a particular case of the second example is considered, in which the elliptic curve has three points of order two and is such that ε=1. Also, an operation of the type P3=P1+P2 is carried out, with P1, P2 any two points whatsoever on the elliptic curve. P2 can be different from P1, equal to P1 and/or equal to the neutral O of the curve. The addition operation is given in Jacobi projective coordinates for the model U⁴−2δ.U².W²+W4 corresponding to the affine model Y²=X⁴+2δ.X²+1.

The equation F24 is ultimately a particular case of the most general equation F10, with a0=1, a1=0, a2=−2δ, a3=0, a4=1.

When the exponentiation calculation device is called upon to carry out an addition operation, the central processing unit 2 first of all stores in calculation registers the coordinates (U1:V1:W1) and (U2:V2:W2) of the points P1, P2 on the elliptic curve which are to be added.

The central processing unit 2 next calculates the coordinates of the point P3 according to the equations:
U3=U1.W1.V2+V1.U2.W2 (F27)
V3=[(W1.W2)²+(U1.U2)²]*[V1.V2−2δU1.U2.W1.W2]+2U1.U2.W1.W2(U1²W2²+W1²U2²) (F28)
W3=(W1.W2)²−(U1.U2)² (F29)

The coordinates (U3:V3:W3) of the point P3 are finally stored in registers in the working memory 8, in order to be used elsewhere, for example for the remainder of the ciphering algorithm.

Here again it is verified that the formulae F27 to F29 are effective, even in the case where P1=P2(point doubling) or in the case where P2=O (addition of the neutral).

From a practical implementation point of view, the formulae F27 to F29 can be implemented as follows:
r1 ρu1.u2
r2 ρw1.w2
r3 ρr1.r2
r4 ρv1.v2
r5 ρu1.w1+v1
r6 ρu2.w2+v2
u3 ρr5.r6−r4−r3
w3 ρ(r2−r1).(r2+r1)
r6 ρδ*r3
r4 ρr4−2.r6
r6 ρ(r2+r1)²−2r3
r4 ρr4.r6
r6 ρ(u1+w1).(u2+w2)−r1-r2
r5 ρr6²−2r3
r6 ρr5.r3
v3 ρr4+2.r6
where u1, v1, w1, u2, v2, w2, u3, v3, w3 are calculation registers in which the projective coordinates of the points P1, P2 and P3 are stored, and r1 to r6 are temporary calculation registers.

Thus, according to this embodiment, the coordinates of the point P3 are obtained in a time equal to approximately 13 times the time for carrying out a multiplication of the contents of two registers+one times the time for carrying out a multiplication of the contents of a register by a constant. The time for calculating the coordinates of P3 by means of the formulation according to the invention is thus much shorter than the time for calculating the coordinates of P3 by means of a formulation such as those of the prior art.

It should be noted that this approximation is entirely realistic since the time for carrying out a multiplication of the contents of a register by a constant or a multiplication of the contents of two registers is in practice very much longer than the time for carrying out an addition of the contents of two registers.

This is also true in the case of implementation of the formulae F15-F17 or F21-F23.

In a fourth example embodiment of the invention, an elliptic curve having a single point of order two with affine coordinates (θ, 0) is considered, and an operation of the type P3=P1+P2 is carried out, with P1, P2 any two points whatsoever on the elliptic curve. P2 can be different from P1, equal to P1 and/or equal to the neutral O of the curve.

As was seen in the second example:
θ³+a.θ+b=0

The curve with Weierstrass equation
Y²=X³+a.X+b
and having a single point (θ, 0) of order two is birationally equivalent to a curve with equation
   Y²=ε.X⁴−2δ.X²⁺¹ (F18)
with:
   ε=−(a+3θ²/4)/4 and δ=3θ/4 (F19)

In this example, the addition operation is given in affine coordinates.

When the exponentiation calculation device is called upon to carry out an addition operation, the central processing unit 2 first of all stores in calculation registers the coordinates (X1, Y1) and (X2, Y2) of the points P1, P2 on the elliptic curve which are to be added.

The central processing unit 2 next calculates the coordinates of the point P3 according to the equations:
X3=(X1.Y2+Y1.X2)/[1−ε(X1.X2)²] (F30)
Y3={[1+ε(X1.X2)²].[Y1.Y2−2δ.X1.X2]+2ε.X1.X2.(X1²+X2²)}/[1−ε(X1.X2)²] (F31)

The coordinates (X3, Y3) of the point P3 are finally stored in registers in the working memory 8, in order to be used elsewhere, for example for the remainder of the ciphering algorithm.

Here again it is verified that the formulae F30 to F31 are valid, even in the case where P1=P2 (point doubling) or in the case where P2=O (addition of the neutral).

1. A method of universal calculation on points on an elliptic curve, wherein the elliptic curve is defined by a quartic equation and identical programmed calculation means are used to carry out an operation of addition of points, an operation of doubling of points, and an operation of addition of a neutral point, the calculation means comprising a central processing unit associated with a memory.

2. A method according to claim 1, wherein the elliptic curve is defined by a quartic equation of the type:
V²=b.U⁴+a.U³W+UW³,
(U:V:W) being Jacobi projective coordinates of a point P on the elliptic curve, and a, b being parameters of the elliptic curve, a point with coordinates (0:0:1) being a neutral point O of the elliptic curve, a point with coordinates (U:−V:W) being an inverse point of the point P with coordinates (U:V:W).

3. A method according to claim 2, in which the point P is also defined in affine coordinates (X, Y), the affine coordinates (X, Y) and the Jacobi projective coordinates (U:V:W) of the point P being linked by the relationships:
(X, Y)=(U/W, V/W²).

4. A method according to claim 2, in which, in order to carry out the addition of a first point P1 defined by first Jacobi projective coordinates (U1:V1:W1) and a second point P2 defined by second Jacobi projective coordinates (U2:V2:W2), the coordinates of the first point P1 and those of the second point P2 being stored in first and second registers in the memory, the first point and the second point belonging to the elliptic curve,
the programmed calculation means calculate third Jacobi projective coordinates (U3:V3:W3) defining a third point P3, the result of the addition, by the following equations:
$$\begin{matrix}U3 = 2. b . {U1}^{2} . {U2}^{2} + ( aU1 . U2 + W1 . W2 ) . ( U1 . W2 + W1 . U2 ) + \\ 2 V1 . V2\end{matrix}$$
$$\begin{matrix}V3 = {( {U1}^{2} . V2 + {U2}^{2} . V1 )}^{*} \\ ( 4 b . ( U1 . W2 + U2 . W1 ) . W1 . W2 - \\ 8 {b}^{2} . {( U1 . U2 )}^{2} + \\ a . [ {( 2 W1 . W2 )}^{2} - {( aU1 . U2 + W1 . W2 )}^{2} ] + \\ {( {W1}^{2} . V2 + {W2}^{2} . V1 )}^{*} \\ [ {( aU1 . U2 + W1 . W2 )}^{2} - {( 2 aU1 . U2 )}^{2} + \\ 4 bU1 . U2 . ( W1 . U2 + U1 . W2 ) ] - \\ 4 bU1 . U2 . ( U1 . W1 . V2 + U2 . W2 . V1 ) ( aU1 . U2 - W1 . W2 )\end{matrix}$$
$$W3 = {( aU1 . U2 - W1 . W2 )}^{2} - 4 bU1 . U2 ( U1 . W2 + U2 . W1 )$$
and then store the third projective coordinates (U3:V3:W3) in third registers in the memory.

5. A method according to claim 1, in which the elliptic curve is a curve comprising a single point of order two and is defined by a quartic equation of the type:
V²=ε.U⁴−2δ. U².W²+W⁴,
(U:V:W) being Jacobi projective coordinates of a point P on the elliptic curve, and ε, δ being parameters of the elliptic curve, the point with coordinates (0:1:1) being the neutral point O of the elliptic curve, the point with coordinates (−U:+V:W) being the inverse point (−P) of the point P (U:V:W).

6. A method according to claim 5, in which, in order to carry out the addition of the first point P1 defined by first Jacobi projective coordinates (U1:V1:W1) and the second point P2 defined by second Jacobi projective coordinates (U2:V2:W2),the coordinates of the first point P1 and those of the second point P2 being stored in first and second registers in the memory, the first point and the second point belonging to the elliptic curve,
the programmed calculation means calculate third Jacobi projective coordinates (U3:V3:W3) defining a third point P3, the result of the addition, by the following equations:
U3=U1.W1.V2+V1.U2.W2
V3=[(W1.W2)²+ε(U1.U2)²]*[V1.V2−2δU1.U2.W1.W2]+2δ.U1.U2.W1.W2(U1²W2²+W1²U2²)
W3=(W1.W2)²−ε(U1.U2)²
and then store the third projective coordinates (U3:V3:W3) in the third registers in the memory.

7. A method according to claim 5, in which the elliptic curve is defined in affine coordinates by an equation of the type:
Y²=ε.X⁴−2δ.X²+1
(X, Y) being affine coordinates of a point P on the elliptic curve.

8. A method according to claim 7, in which, in order to carry out the addition of the first point P1 defined by first affine coordinates (X1, Y1) and the second point P2 defined by second affine coordinates (X2, Y2), the coordinates of the first point P1 and those of the second point P2 being stored in first and second registers in the memory, the first point P1 and the second point P2 belonging to the elliptic curve,
the programmed calculation means calculate third affine coordinates (X3, Y3) defining a third point P3, the result of the addition, by the following equations:
X3=(X1.Y2+Y1.X2)/[1−ε(X1.X2)²]
Y3={[1+ε(X1.X2)²].[Y1.Y2−2δ.X1.X2]+2δ.X1.X2.(X1²+X2²)}/[1−ε(X1.X2)²]
and then store the third affine coordinates (X3, Y3) in the third registers in the memory.

9. A method according to claim 5, in which the elliptic curve is a curve comprising three points of order two and has ε=1 as a parameter.

10. Use of a calculation method according to claim 1 in a scalar multiplication calculation method applied to points on an elliptic curve.

11. Use of a calculation method according to claim 1 in a cryptographic method.

12. An electronic component comprising programmed calculation means for implementing a method according to claim 1, the calculation means comprising in particular a central processing unit associated with a memory.

13. An electronic component comprising means for implementing a cryptographic algorithm using a method according to claim 1.

14. A smart card comprising an electronic component according to claim 12.
